(19) United States
(12) Patent Application Publication
(10) Pub. No.: US 2014/0223652 A1
(43) Pub. Date: Aug. 14, 2014

(54) Toilet Seat and Manufacturing Method Thereof

(71) Applicant: WOONGJIN COWAY CO., LTD., Choongcheongnam-do (KR)

(72) Inventors: Sung-Worl Jin, Gwanak-gu (KR); Young-Pyo Kim, Gwanak-gu (KR); Chun-Ho Park, Gwanak-gu (KR); Joong-Keun An, Gwanak-gu (KR); Hee-Ju Kang, Gwanak-gu (KR)

(73) Assignee: COWAY CO., LTD, Choongcheongnam-do (KR)

(21) Appl. No.: 14/349,116

(22) PCT Filed: Oct. 26, 2012
(86) PCT No.: PCT/KR2012/008872

§ 371 Date: Apr. 2, 2014

(30) Foreign Application Priority Data
Oct. 27, 2011 (KR) 10-2011-0110397
Aug. 17, 2012 (KR) 10-2012-0089879

(51) Int. Cl. A47K 13/30; B29C 45/14; B29C 45/00

(52) U.S. Cl. CPC A47K 13/305; B29C 45/0017; B29C 45/14065; B29C 45/14819; B29C 45/14311; B29C 2045/14327; B29L 2031/771
USPC 4/237; 264/255

(57) ABSTRACT

There are provided a method for manufacturing a toilet seat, and a toilet seat. The method for manufacturing a toilet seat includes: a primary injecting operation to inject a resin into an upper injection mold and a lower injection mold to injection mold an upper body and a lower body constituting a toilet seat body; a heater mounting operation to mount a heater on one surface of the upper body by using a heater jig; a secondary injecting operation to inject a resin in a state in which the upper body and the lower body are brought into contact with each other, to close a gap in the toilet seat body; and a toilet seat body extracting operation to extract the toilet seat body from the upper injection mold and the lower injection mold.

### TECHNICAL FIELD

The present invention relates to a toilet seat and a manufacturing method thereof, and more particularly, to a toilet seat in which a gap is minimized and an internal heater is stably installed, and a manufacturing method thereof.

### BACKGROUND ART

A restroom toilet includes a toilet seat upon which a toilet user may be seated, and such a toilet seat may be installed such that it is attached to the top of the toilet bowl.

The toilet seat is provided by assembling an upper toilet seat half and a lower toilet seat half, and a hot wire may be installed within the toilet seat to maintain the toilet seat at a temperature close to body temperature to allow a user to he comfortably seated thereon to relieve himself.

In order to assemble the upper toilet seat half and the lower toilet seat half, a method of melting junction surfaces therebetween through ultrasonic welding, vibration welding, or the like, is used.

However, in assembling the two components, there may be a gap therebetween and water or feces may infiltrate into the gap. When feces infiltrates and is accumulated therein, contaminants cannot be completely removed, even with a cleaning outfit, and frequent cleaning of the gap may extend the width of the gap to result in damage to waterproofing.

Also, due to the gap, water may permeate to the hot wire installed within the toilet seat, thereby risking a short circuit or an electric shock.

Meanwhile, in a method of assembling the upper toilet seat half and the lower toilet seat half by fusing the junction surfaces of the conventional upper toilet seat half and lower toilet seat half, injection molding is performed to connect the upper toilet seat half and the lower toilet state in a state in which the upper toilet seat half and the lower toilet seat half are brought into contact with each other.

Also, in order to install a hot wire as a heater, before fusing the junction surfaces of the toilet seats, a hole is formed in a hinge portion of the toilet seat halves, an electrical wire of the heater is extracted and injection molding products are subsequently fused, the heater is formed by a worker attaching hot wire-attached aluminum to the upper toilet seat half.

However, in the related art injection-molding method, since the upper toilet seat half and the lower toilet seat half are separately fabricated, the heater is attached thereto manually, and the fusing process is subsequently performed to couple the upper toilet seat half and the lower toilet seat half, the fabrication process is complicated, a manufacturing time is lengthened, and it may be difficult to perform a precise operation.

### DISCLOSURE OF INVENTION

### Technical Problem

An aspect of the present invention provides a method for manufacturing a toilet seat in which a gap is not formed between coupled portions to prevent water or feces from infiltrating thereinto to thus prevent the interior of the toilet seat from being contaminated and prevent water from infiltrating into a heater disposed within the toilet seat to thus prevent a generation of an electric shock, and a toilet seat manufactured thereby.

An aspect of the present invention also provides a method for manufacturing a toilet seat capable of simplifying an operation to install a heater in a toilet seat, shortening a fabrication time, and performing a precise heater attaching operation, and a toilet seat.

An aspect of the present invention also provides a method for manufacturing a toilet seat capable of minimizing deformation of a lower body thereof by a resin having a high temperature and a high pressure injected in a secondary injection molding stage, and a toilet seat.

### Solution to Problem

According to an aspect of the present invention, there is provided a method for manufacturing, a toilet seat, including: a primary injecting operation to inject a resin into an upper injection mold and a lower injection mold to injection mold an upper body and a lower body constituting a toilet seat body: a heater mounting operation to mount a heater on one surface of the upper body by using a heater jig; a secondary injecting operation to inject a resin in a state in which the upper body and the lower body are brought into contact with each other, to close a gap in the toilet seat body; and a toilet seat body extracting operation to extract the toilet seat body from the upper injection mold and the lower injection mold.

Preferably, the method may further include: moving the lower injection mold to a position in which the lower body corresponds to the upper body, before the mounting of the heater.

Preferably, the mounting of the heater may include a heater fixing operation of fixing the heater to one surface of the heater jig; a heater jig inserting operation to move the heater-mounted heater jig to a position between the upper body and the lower body; a heater attaching operation to close the upper injection mold and the lower injection mold to attach the heater to the upper body; and a heater jig extracting operation to extract the heater jig.

Preferably, the mounting of the heater may include: a heater fixing operation of fixing the heater to one surface of the heater jig; a heater attaching operation to move the heater jig to the upper body to attach the heater to the upper body; and an upper body moving operation to move the heater-attached upper body to a position corresponding to the lower body.

Here, preferably, the upper body may be injection-molded by injecting a resin into the lower injection mold, and in the upper body moving operation, the upper body may be disposed in a position corresponding to the lower body by moving the lower injection mold.

Also, preferably, the secondary injecting operation may include: molding a joint injection portion by injecting a resin into a joint recess portion formed by a first joint recess portion provided on an outer side of the first hinge recess portion of the upper body and a second joint recess portion provided on an outer side of the second hinge recess portion of the lower body.

More preferably, the secondary injecting operation may include: injection-molding a gap injection portion by injecting a resin into a space between an inner partition provided on an lower surface of the upper body and an outer surface of the upper body.

Meanwhile, preferably, the lower body may include a plurality of resin injection holes formed in a penetrative manner to communicate with the space between the outer surface of the upper body and the inner partition and formed along the circumference of the lower body, and in the secondary injecting operation, the gap injection portion may be molded by injecting a resin through the plurality of resin injection holes.

Preferably, the lower body may include a reinforcing rib installed to be protruded in the vicinity of the resin injection holes to prevent the upper body and the lower body from being deformed by the resin injected in the secondary injecting operation.

Preferably, the lower body may include a blocking rib protruded to correspond to the inner partition of the upper body, and the reinforcing rib may be provided as a plurality of vertical ribs protruded in a direction perpendicular to the blocking rib.

Preferably, the lower body may include a blocking rib protruded to correspond to the inner partition of the upper body, and the reinforcing rib may be provided as a grid rib coupled to one surface of the blocking rib as a grid.

Meanwhile, preferably, in the primary injecting operation, the upper body and the lower body may be molded simultaneously.

Meanwhile, preferably, in the primary injecting operation, an overlap portion may be formed to extend to have a certain length on an outer end portion of the upper body and an end portion of the inner partition in order to prevent a formation of a gap due to contraction of the upper body and the lower body after the primary injecting operation.

Meanwhile, according to an aspect of the present invention, there is provided a toilet seat including: a toilet seat body including an upper body having a heater mounted on a lower surface thereof and a lower body combined with the upper body; and a hinge unit provided in one side of the toilet seat body and having an outlet allowing an electrical wire of the heater to be led out therethrough, wherein a gap generated as the upper body and the lower body of the toilet seat body are combined is blocked through a secondary injecting operation, and the hinge unit may be formed by combining a first hinge recess portion formed on the upper body and a second hinge home recess portion formed on the lower body through a secondary injecting operation.

Preferably, the hinge portion may include a joint injection portion formed by injection molding a resin to form a recess portion formed by a first joint recess portion formed on an outer side of the first hinge recess portion and a second joint recess portion formed on the second hinge recess portion.

Also, preferably, the upper body may include an inner partition formed on a lower surface thereof, and a gap injection portion injection-molded by injecting a resin into a space between an outer surface and the inner partition wall thereof.

Meanwhile, preferably, the lower body may include; a blocking rib formed to be protruded to correspond to the inner partition wall of the upper body; and a plurality of reinforcing ribs formed to be protruded in a direction perpendicular to the blocking rib in order to reinforce the strength of the blocking rib.

Meanwhile, preferably, the lower body may include: a blocking rib formed to be protruded to correspond to the inner partition wall of the upper body; and a reinforcing rib coupled to one surface of the blocking rib as a grid in order to reinforce the strength of the blocking rib.

Meanwhile, preferably, the upper body may include: an overlap portion formed to extend to have a certain length on an outer end portion of the upper body and an end portion of the inner partition such that the upper body and the lower body can be combined in an overlapping manner.

### ADVANTAGEOUS EFFECTS OF INVENTION

As set forth above, according to embodiments of the invention, in case of the method for manufacturing a toilet seat and the toilet seat, since a gap is not formed in a combined portion of the upper body and the lower body, water or feces cannot infiltrate into the toilet seat, thus preventing the interior of the toilet from being contaminated, and a generation of an electric shock due to an infiltration of water to the heater disposed within the toilet seat can also be prevented.

Further, according to embodiments of the present invention, since the heater is attached by using a heater jig in the process of manufacturing the toilet seat by injection-molding the upper body and the lower body, the operation of installing the heater in the toilet seat can be simplified, the manufacturing time can be shortened, and a precise operation can be performed in attaching the heater.

Further, according to embodiments of the present invention, since the upper body and the lower body are simultaneously molded in one device, productivity can be enhanced.

Further, according to embodiments of the present invention, since rigidity of the reinforcing rib and the lower body in the vicinity of the resin injection hole and the blocking rib are reinforced by injecting a secondary injection molded product through a plurality of resin injection holes, deformation of the lower body 230 due to high temperature and high pressure resin injected in the secondary injecting operation can he minimized.

Further, according to embodiments of the present invention, an overflow of the resin injected in the secondary injecting operation to the outside of the space in which the gap injection portion is formed, due to the contraction stemming from cooling of the primary injection-molded product can be prevented by the overlap portion formed on the upper body.

### BRIEF DESCRIPTION OF DRAWINGS

FIG. 1 is a view schematically illustrating a method for manufacturing a toilet seat according to an embodiment of the present invention;

FIG. 2 is a perspective. view illustrating the toilet seat according to an embodiment of the present invention;

FIG. 3 is an exploded perspective view of the toilet seat illustrated in FIG. 2;

FIG. 4 is a view illustrating an upper body and a heater applied to an embodiment of the present invention;

FIG. 5 is an enlarged perspective view of portion ‘A’ in FIG. 2;

FIG. 6 is a cross-sectional view taken along line B-B′ in FIG. 2;

FIG. 7 is an exploded perspective view of a toilet seat according to another embodiment of the present invention;

FIG. 8 is a cross-sectional view of the toilet seat according to another embodiment of the present invention;

FIG. 9 is an enlarged perspective view of portion ‘C’ in FIG. 8;

FIG. 10 is a partially enlarged perspective view illustrating a modification of a reinforcing rib illustrated in FIGS. 7; and

FIG. 11 is a view schematically illustrating a method for manufacturing a toilet seat according to another embodiment of the present invention.

### MODE FOR THE INVENTION

Embodiments of the present invention will now be described in detail with reference to the accompanying drawings. The invention may, however, be embodied in many different forms and should not be construed as being limited to the embodiments set forth herein. Rather, these embodiments are provided so that this disclosure will he thorough and complete, and will fully convey the scope of the invention to those skilled in the art. In the drawings, the shapes and dimensions of elements may be exaggerated for clarity, and the same reference numerals will be used throughout to designate the same or like components.

To begin with, embodiments described hereinafter are appropriate for understanding technical characteristics of a toilet seat and a manufacturing method thereof of the present invention. However, the present invention is not limitedly applied to the embodiments described hereinafter, while technical characteristics of the present invention are not limited by the described embodiments, and various modifications may be made within a technical range of the present invention.

A toilet seat according to an embodiment of the present invention may be placed on an upper portion of a toilet bowl, and one side thereof may be rotatable hinge-combined with a bidet main body (not shown), A bidet cleaning nozzle is installed to be movable in a forward/backward direction in the bidet main body. Thus, when a user executes a cleaning function after reliving himself, the cleaning nozzle moves forwardly to jet water to clean the user's external organs of sex and excretion.

Also, a heater providing heat to the toilet seat may be installed within the toilet seat. A manipulation unit controlling a function of the bidet may be installed in one external portion of the bidet main body, and the user may move the cleaning nozzle or operate the heater by manipulating the manipulation unit.

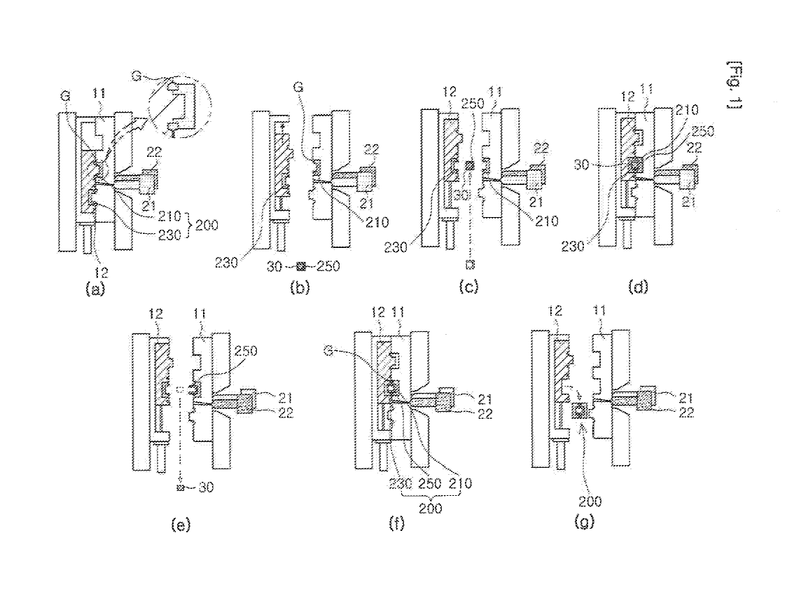

Hereinafter, a method for manufacturing a toilet seat according to an embodiment of the present invention will be described with reference to FIGS. 1 through 6.

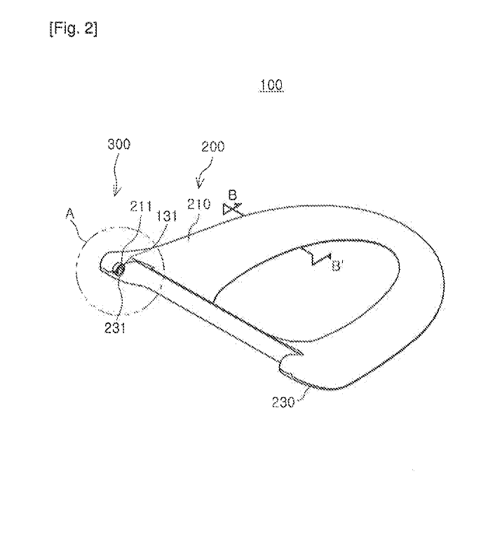

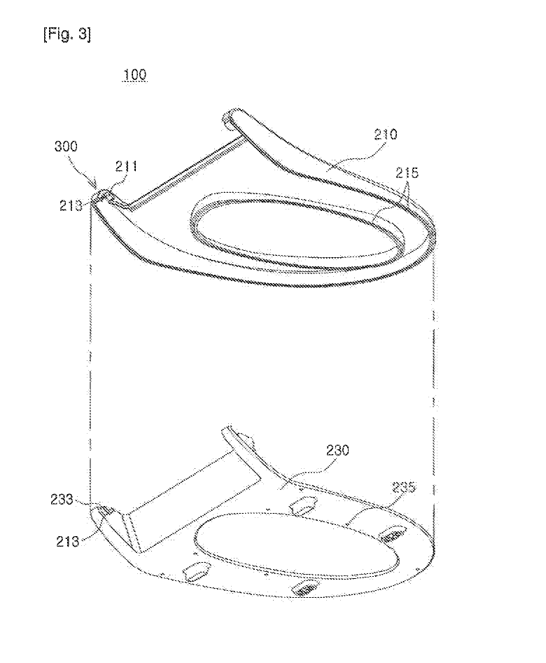

FIG. 1 is a view schematically illustrating a method for manufacturing the toilet seat 100 according to an embodiment of the present invention. FIG. 2 is a perspective view illustrating the toilet seat 100 according to an embodiment of the present invention, FIG. 3 is an exploded perspective view of an upper body 210 and a lower body 230 for manufacturing a toilet seat body 200 of the toilet seat illustrated in FIG. 2. Here, FIG. 1 is a conceptual view illustrating: a method for manufacturing the toilet seat, so that shapes of elements thereof may not be identical to those using the same reference numerals among the elements illustrated in FIGS. 2 through 6.

As shown in the embodiment illustrated in FIG. 1, a method for manufacturing the toilet seat 100 according to an embodiment of the present invention may include a primary injecting operation to inject a resin into injection molds 11 and 12 to injection-mold an upper body 210 and a lower body 230 constituting the toilet seat body 200, a heater mounting operation to mount a heater 250 on one surface of the upper body 210 by using a heater jig 30, a secondary injecting operation to inject a resin in a state in which the upper body 210 and the lower body 230 are brought into contact with each other to close a gap in the toilet seat body 200, and a toilet seat body extracting operation to extract the toilet seat body 200 from the injection molds 11 and 12.

In this case, preferably, the method may further include an operation to move the lower injection mold 12 to move the lower body 230 to a position corresponding to the upper body 210, before the heater mounting operation.

First, as shown in the embodiment illustrated in FIG. 1(a), in the primary injecting operation, a resin is injected into the upper injection mold 11 and the lower injection mold 12 by using a primary injection runner 21 to injection mold the upper body 210 and the lower body 230 constituting the toilet seat body 200.

Namely, in the toilet seat 100 according to an embodiment of the present invention, in order to manufacture the toilet seat body 200 illustrated in FIG. 2, the upper body 210 and the lower body 230 may be manufactured and assembled.

In this case, the upper body 210 and the lower body 230 may be molded simultaneously.

Namely, as shown in the illustrated embodiment, the resin is injected in a state in which the upper injection mold 11 and the lower injection mold 12 are brought into contact with each other to simultaneously form the upper body 210 and the lower body 230. Thus, the process of manufacturing the toilet seat is simple and a processing time is shortened. However, the present invention is not limited thereto and, for example, the upper body 210 and the lower body 230 may be manufactured in separate processes or may be manufactured sequentially.

Meanwhile, grooves G formed in the upper body 210 and the lower body 230, which correspond to a joint injection portion 330 of a hinge unit 300 and a gap injection portion 217 of the upper body 210, are injected with resin in the secondary injection operation. The joint injection portion 330 and the gap injection portion 217 will be described in detail later.

Next, as shown in the embodiment illustrated in FIG. 1(b), the lower injection mold 12 is automatically moved to move the lower body 230 to a position corresponding to the upper body 210.

As shown in the embodiment illustrated in FIGS. 1(b) to 1(e), the heater 250 may be mounted on one surface of the upper body 210 by using the heater jig 30.

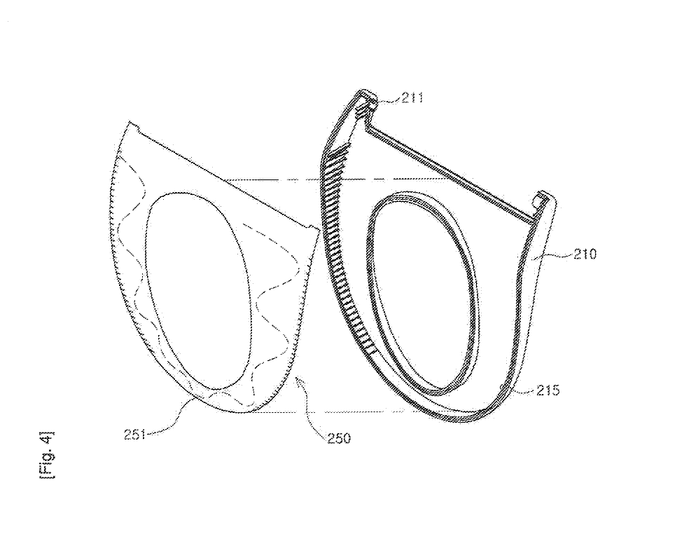

Here, as shown in the embodiment illustrated in FIG. 4, the heater 250 may be configured by installing a hot wire in an aluminum sheet, and the heater 250 may be attached within a hollow portion between the upper body 210 and the lower body 230, e.g., to a lower surface of the upper body 210.

Namely, the heater 250 may be configured in the form of a hot wire and adhered to a lower surface of the casing of the upper body 210 by using the aluminum sheet. In this respect, however, when aluminum foil with the hot wire attached thereto is directly attached to the lower surface of the upper body 210 by using tape, or the like, it may be difficult to perform a precise operation to accurately attach the heater 250 to a desired position of the lower surface of the upper body 210 and a long period of time may be required for the operation.

In comparison, in the embodiment of the present invention, since the heater 250 is fixed to the heater jig 30 and attached to the upper body 210, the operation process is simplified and the heater 250 can be precisely attached to the upper body 210 in a desired position, relative to the case of attaching the heater 250 to the upper body 210,

Also, since the heater 250 is attached to the upper body 210 by using the heater jig 30 that can be automatically movable in the hollow injection process of manufacturing the toilet seat body 200, the manufacturing process of the toilet seat 100 can be simplified and a manufacturing time can be shortened.

Thereafter, as shown in the embodiment illustrated in FIG. 1(f), in a state in which the upper body 210 and the lower body 230 are brought into contact with each other, a secondary injection operation may be performed to inject a resin to fill a gap in the toilet seat body 200.

Namely, the resin may be secondarily injected into the illustrated grooves G by using the secondary injection runner 22 to form the joint injection portion 330 blocking a gap in the hinge unit 300 and the gap injection portion 217 blocking a gap according to assembly of the upper body 210 and the lower body 230 as described hereinafter.

Thus, the toilet seat 100 according to an embodiment of the present invention does not have a gap in the portion in which the upper toilet seat half and the lower toilet seat half, thus preventing water or feces from infiltrating to contaminate the interior of the toilet seat, and also, since water cannot infiltrate into the heater 250 disposed within the toilet seat body 200, an electric shock cannot occur. Also, since the secondary injection is used to couple the hinge unit 300, an electrical wire of the heater 250 can be stably installed.

When the secondary injection operation is completed, as illustrated in FIG. 1(g), the upper injection mold 11 and the lower injection mold 12 may be open to extract the toilet seat body 200.

Meanwhile, the heater mounting operation will be described in detail with reference to FIGS. 1(h) to 1(e).

The heater mounting operation may include a heater fixing operation, a heater jig inserting operation, a heater attaching operation, and a heater jig extracting operation.

As shown in the embodiment illustrated in FIG. 1(b), the heater fixing operation may be performed by fixing the heater 250 to one surface of the heater jig 30. Here, the heater 250 may be fixed to one surface of the heater jig 30 at the side of the upper body 210 so as to be attached to the upper body 210.

Thereafter, as illustrated in FIG. 1(c), the heater jig inserting operation may be performed by moving the heater jig 30 with the heater 250 mounted thereon to a space between the upper body 210 and the lower body 230. Namely, the heater jig 30 may he moved to a space between the upper body 210 and the lower body 230 attached to the injection molds 11 and 12, respectively, and inserted.

Meanwhile, as illustrated in FIG. 1(d), the heater attaching operation may be performed. by attaching the heater to the upper body 210 by closing the upper injection mold 11 and the lower injection mold 12. Namely, the heater jig 30 with the heater 250 mounted thereon is inserted into a space between the upper body 210 and the lower body 230 and the injection molds 11 and 12 are subsequently closed to attach the heater 250 to the upper body 210.

Thereafter, as shown in the embodiment illustrated in FIG. 1(e), the heater jig extracting operation may be performed to open the injection molds 11 and 12 and extract the heater jig 30.

Meanwhile, the secondary injection operation may include molding the joint injection portion 330 by injecting a resin into a joint recess portion 310 formed as a first joint recess portion 213 provided on an outer side of a first hinge recess portion 211 of the upper body 210 and a second joint recess portion 233 provided on an outer side of a second hinge recess portion 231 of the lower body 230 are combined.

Namely, referring to FIGS. 2, 3, and 5, the hinge unit 300 is provided in one side of the toilet seat body 200, and an outlet 320 may be formed in the hinge unit to allow an electrical wire of the heater 250 mounted within the toilet seat body 200 to be led out. Here, for example, the outlet 320 may be formed by combining the first hinge recess portion 211 and the second hinge recess portion 231 formed to have a semicircular shape, respectively.

Thus, in the hollow injection process, the first hinge recess portion 211 and the second hinge recess portion 231 having a semicircular shape, respectively, are formed in the hinge unit 300 and, for example, a rubber cap in which an electrical wire (not shown) of the heater 250 is installed, or the like, may be inserted into the first hinge recess portion 211, whereby the electrical wire (not shown) of the heater 250 may be stably led out. Namely, in the case of the method for manufacturing a toilet seat according to an embodiment of the present invention, the hinge units 300 are manufactured to have a semicircular shape and are coupled, and thus, the heater 250 and the electrical wire connected to the heater 250 can be stably and effectively installed.

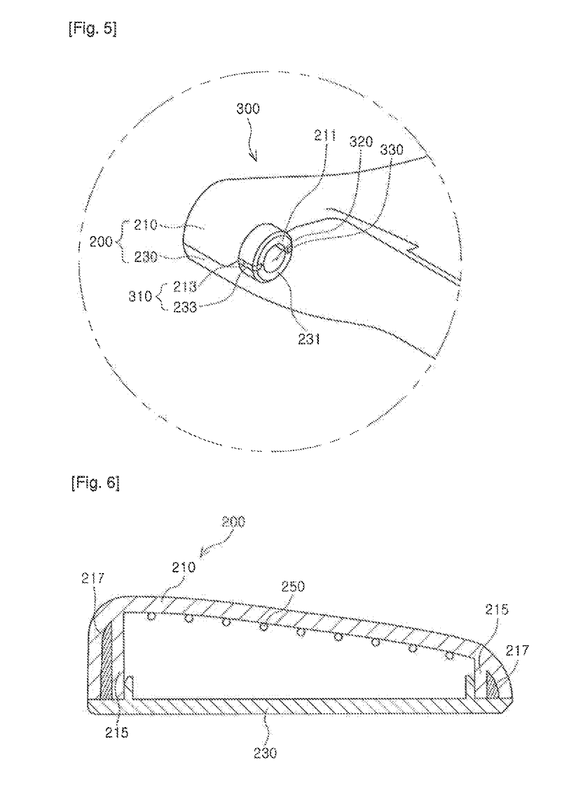

Here, as shown in the embodiment illustrated in FIG. 5, the upper body 210 may be molded such that the first joint recess portion the first joint recess portion 213 is formed in an outer side of the first hinge recess portion 211, and the lower body 230 may be molded such that the second joint recess portion 233 is formed in an outer side of the second hinge recess portion 231. The first joint recess portion 213 and the second joint recess portion 233 form the joint recess portion 310 in a state in which the upper body 210 and the lower body 230 are brought into contact with each other, and the joint injection portion 330 may be molded by injecting a resin in the secondary injection operation.

In this manner, since the joint injection portion 330 is formed through secondary injection in the portion in which the first hinge recess portion 211 and the second hinge recess portion 231 constituting the hinge unit 300 are combined, a gap is not formed in the combined portion, thus preventing water or feces from infiltrating thereinto, and since the electrical wire of the heater led out through the outlet 320 can be stably installed, an electric shock accident can thus be minimized.

Meanwhile, the secondary injection operation may include injection-molding the gap injection portion 217 by injecting a resin into a space between an inner partition 215 provided on a lower surface of the upper body 210 and an outer surface of the upper body 210.

Referring to FIGS. 3 and 6, the upper body 210 may be molded to include the inner partition 215 formed on the lower surface thereof. Namely, the upper body 210 may be formed to have a dual-partition structure including the outer surface and the inner partition 215 to prevent infiltration of water or feces. Here, the inner partition may be formed in at least any one of an inner side and an outer side of the upper body 210, but preferably, in order to reliably block introduction of water, the inner partition may be formed in both of the inner side and the outer side.

Here, when the upper body 210 and the lower body 230 are combined, a gap may be formed due to assembling, and water or feces may infiltrate into to the gap. Thus, in the secondary injecting operation, the gap injection portion 217 may be injection-molded by injecting a resin into the space between the outer surface and the inner partition 215 in the secondary injecting operation.

As shown in the embodiment illustrated in FIG. 3, the lower body 230 may be formed in a penetrative manner to communicate with a space between the outer surface and the inner partition 215 of the upper body 210, and include a plurality of resin injection holes 235 formed along the circumference thereof.

Thus, the gap injection portion 217 is formed by injecting a resin into the space between the inner partition 215 and the outer surface of the upper body 210 through the resin injection holes 235

Also, in the secondary injecting operation, the gap injection portion 217 may be molded by simultaneously injecting a resin through the plurality of resin injection holes 235.

Thus, the secondary injecting operation to form the gap injection portion 217 may be performed within a short time in comparison to the case in which a resin is injected into a single resin injection hole 235, and thus, deformation of the upper body 210 and the lower body 230 as primarily injection-molded products in the vicinity of the resin injection holes 235 can be minimized.

In this manner, the formation of a gap in combining the upper body 210 and the lower body 230 is prevented by the gap injection portion 217 formed as described above, and thus, an infiltration of water or feces can be reliably blocked, and the heater 250 may be stably installed within the toilet seat body 200.

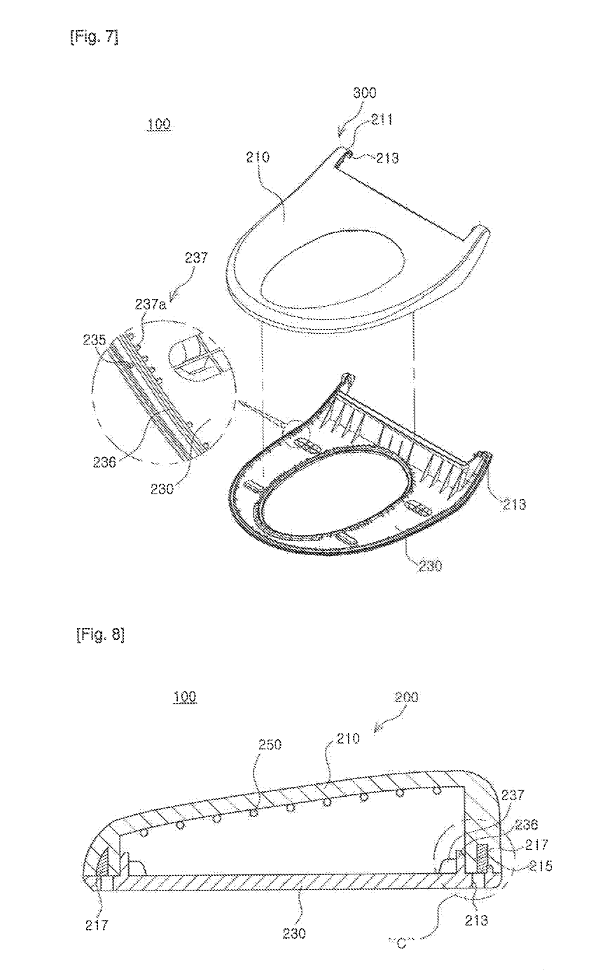

Meanwhile, another embodiment of the toilet seat 100 according to a method for manufacturing a toilet seat according to an embodiment of the present invention will be described with reference to FIGS. 7 through 10.

Referring to FIGS. 7 through 10, the lower body 230 may include a reinforcing rib 237 installed to be protruded to be adjacent to the resin injection hole 235 in order to prevent the upper body 210 and the lower body 230 from being deformed by a resin injected in the secondary injecting operation.

Here, the lower body 230 may include a blocking rib 236 formed to be protruded to correspond to the inner partition 215 of the upper body 210. The blocking rib 236 may be formed in a position corresponding to the inner partition 215 so as to be joined to the inner partition 215, and may serve to prevent a resin injected to form the gap injection portion 217 from overflowing to the outside.

Preferably, the reinforcing rib 237 may he installed to be joined to the blocking rib 235 installed to be adjacent to the resin injection hole 235. Thus, the reinforcing rib 237 is able to reinforce rigidity (or stiffness) of the lower body 230 in the vicinity of the resin injection hole 235 and the blocking rib 236, thus minimizing the lower body 230 from being deformed by a high temperature and high pressure resin injected in the secondary injecting operation. Also, since deformation of the blocking rib 236 is minimized, a gap between the upper body 210 and the lower body 230 can be minimized.

However, the installation of the reinforcing rib 237 is not limited to the case in which the reinforcing rib 237 is joined to the blocking rib 236, Namely, for example, when the blocking rib 236 is not installed, the reinforcing rib 237 may be installed to be protruded in the vicinity of the resin injection hole 235. Also, the reinforcing rib 237 is not limited to the case in which the reinforcing rib 237 is formed in the vicinity of the resin injection hole 235, and as in the illustrated embodiment, the reinforcing ribs 237 may be installed at certain intervals in the vicinity of the blocking rib 236,

Meanwhile, the reinforcing rib 237 may be configured as a plurality of vertical ribs 237a formed to be protruded in a vertical direction on the blocking rib 236.

Namely, as shown in the embodiment illustrated in FIG. 7, the vertical ribs 236a may be installed to be perpendicular to both of the blocking rib 236 and a bottom surface of the lower body 230. Thus, when a resin is injected through the resin injection hole 235, the vertical ribs 237a may increase shoring strength of the blocking rib 236 to minimize deformation.

Meanwhile, the reinforcing rib 237 may be configured as a grid rib 237b coupled to one surface of the blocking rib 236 as a grid.

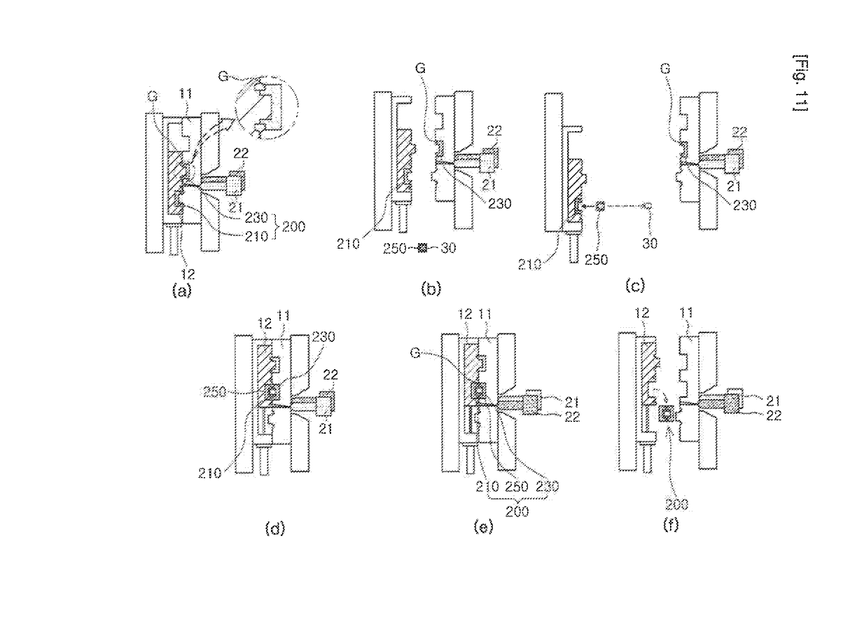

Namely, as shown in the embodiment illustrated in FIG. 10, the grid rib 237b may be joined to the blocking rib 236 and a bottom surface of the lower body 230 and configured as a grid in which horizontal and vertical ribs intersect with each other, Thus, since stress is distributed between the horizontal and vertical ribs of the grid rib 237b, shoring strength of the blocking rib 236 can be increased, relative to the vertical ribs 237a, thus maximizing the effect of minimizing deformation of the lower body 230.

However, the reinforcing rib 237 is not limited to the vertical rib 237a or the grid rib 237b and may be variously modified as long as it can minimize deformation of the lower body 230 in the vicinity of the resin injection hole 235.

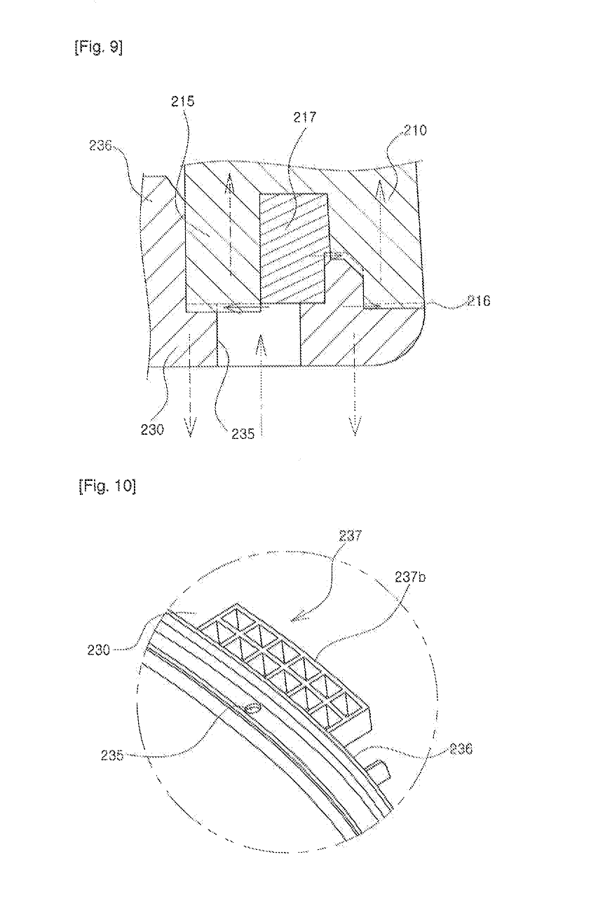

Meanwhile, referring to FIGS. 8 and 9, the primary injecting operation may be performed to form an overlap portion 216 extending to have a certain length on an outer end portion of the upper body 210 and on an end portion of the inner partition 215 to prevent the formation of a gap due to contraction between the upper body 210 and the lower body 230 after the primary injecting operation.

Here, the dotted lines in FIG. 9 denote a direction in which the lower body 230 and the upper body 210 contract due to cooling after the primary injecting operation, the alternate long and short dashed line arrow denotes a direction in which a resin is injected after a secondary injecting operation, and solid line arrows denote a direction in which the injected resin may overflow.

Namely, the overlap portion 216 is formed to extend to have a certain length in the outer end portion of the upper body 210 and the end portion of the inner partition 215 such that the upper body 210 and the lower body 230 are joined when they are brought into contact to be combined.

Thus, a problem, in which the resin injected in the secondary injecting operation overflows from an outer side of the space formed by the gap injection portion 217 due to contraction according to cooling of a primary injection molded product in case that the upper body 210 and the lower body 230 are designed such that end portions thereof are joined without an overlap portion therebetween, can be solved, and the upper body 210 and the lower body 230 can be tightly attached even after the cooling.

In this case, in consideration of contraction due to cooling of the primary injection molded product, the overlap portion 216 may be designed to be overlapped by more than a certain length in a primary injection molded product designing operation such that portions having a certain length may overlap in spite of the generated contraction. Here, the amount of overlap on a design may he increased or decreased according to a type of an injection molded product.

Meanwhile, FIG. 11 is a view schematically illustrating a method for manufacturing a toilet seat according to another embodiment of the present invention.

Referring to FIG. 11, a method for manufacturing a toilet seat according to another embodiment of the present invention is different in a heater mounting operation (See FIGS. 11(b) to 11(d) from the method for manufacturing a toilet seat according to an embodiment of the present invention as described above. Thus, hereinafter, a detailed description of the same configuration as the foregoing configuration will he omitted,

The heater mounting operation applied to another embodiment of the present invention may include a heater fixing operation to fix the heater 250 to one surface of the heater jig 30, by moving the heater jig 30 to the upper body 210, and an upper body moving operation to move the upper body 210 with the heater 250 attached thereto to a position corresponding to the lower body 230.

Here, unlike the foregoing embodiment, the upper body 210 may be injection-molded by injecting a resin into the lower injection mold 12. Namely, since the upper body 210 is injection-molded by using the movable lower injection mold 12, the heater 250 can be easily attached in the heater mounting operation as described hereinafter.

As shown in the embodiment illustrated in FIG. 11(b), the heater fixing operation may be performed by fixing the heater 250 to one surface of the heater jig 30. Here, the heater 250 may be fixed to one surface of the heater jig 30 at the side of the upper body 210, such that it can be attached to the upper body 210.

Thereafter, as shown in the embodiment illustrated in FIG. 11(c), in the heater attaching operation, the lower injection mold 12 is moved downwardly, the heater jig 30 is moved so as to he attached to the upper body 210. Here, after the heater 250 is attached, the heater jig 30 may be returned to its original position. Thus, an operation of extracting the heater jig 30 after the heater 250 is attached can be omitted.

Next, as shown in the embodiment illustrated in FIG.. 11(d), the upper body moving operation may be performed by moving the upper body 210 with the heater 250 attached thereto to a position corresponding to the lower body 230. Here, the upper body 210 may he disposed at a position corresponding to the lower body by moving the lower injection mold 12.

As mentioned above, after the heater 250 is installed in the upper body 210, the secondary injecting operation (See FIG. 11(e)) and the toilet seat body extracting operation (See FIG. 11(f) are performed to manufacture the toilet seat.

According to the method for manufacturing a toilet seat according to another embodiment of the present invention, since the upper body 210 is injection-molded by using the movable lower injection mold, a process of closing the upper injection mold 11 and the lower injection mold 12 to attach the heater is omitted, simplifying the heater mounting operation.

Hereinafter, an embodiment of the toilet seat 100 according to another aspect of the present invention will he described.

As shown in the embodiment illustrated in FIGS. 2, 3, and 5, the toilet seat 100 according to an embodiment of the present invention may include the toilet seat body 200 and the hinge unit 300. FIG. 5 is an enlarged view of portion ‘A’ in FIG. 2.

The toilet seat body 200 may include, the upper body 210 with the heater 250 mounted on a lower surface thereof, and the lower body 230 combined with the upper body 210. A gap formed as the upper body 210 and the lower body 230 of the toilet seat body 200 are combined may be blocked through a secondary injecting operation.

Namely, in the toilet seat 100 according to an embodiment of the present invention, the upper body 210 and the lower body 230 constituting the toilet seat body 200 are molded by using the injection molds 11 and 12 through a primary injecting operation, and a gap formed as the upper body 210 and the lower body 230 are combined is blocked through a secondary injecting operation. Namely, the toilet seat 100 according to an embodiment of the present invention may he manufactured in the dual-injecting scheme.

Meanwhile, the hinge unit 300 is provided in one side of the toilet seat body 200, and may have an outlet 320 allowing an electrical wire of the heater 250 to be led out therethrough.

Namely, in the toilet seat body 200, the heater 250 is mounted on a lower surface of the upper body 210, and the hinge unit 300 having the outlet 320 formed at one side of two hinge-combined portions provided in one side of the toilet seat body 200 is provided to allow an electrical wire of the heater 250 to be led out through the outlet 320.

Also, the hinge unit 300 may be configured by combining the first hinge recess portion 211 formed in the upper body 210 and the second hinge recess portion 231 formed in the lower body 230 through a secondary injecting operation.

Namely, instead of forming an outlet as an annular hole and extracting a heater electrical wire as in the related art, in case of the hinge unit 300, the first hinge recess portion 211 is formed on the upper body 210 and the second hinge recess portion 231 is formed on the lower body 230, a heater electrical wire is fixedly combined with any one of the first hinge recess portion 211 and the second hinge recess portion 231, thus forming the outlet 320, and this method may be used. Thus, an operation time can be shorted, and thus, the heater 250 can be more effectively mounted on the toilet seat 100.

The first hinge recess portion 211 and the second hinge recess portion 231 are integrally joined through a secondary injecting operation to form the outlet 320, whereby a gap that may be generated in the hinge unit 300 can be blocked and the heater electrical wire can be stably led out.

Meanwhile, the hinge unit 300 may include the joint injection portion 330 formed by injection molding a resin to form the joint recess portion 310 formed by the first joint recess portion 21.3 formed on an outer side of the first hinge recess portion 211 and the second joint recess portion 233 formed on the second hinge recess portion 231.

Namely, the upper body 210 may he molded such that the first joint recess portion 213 is formed on an outer side of the first hinge recess portion 211 and the lower body 230 may be molded such that the second joint recess portion 233 is formed on an outer side of the second hinge recess portion 231. The first joint recess portion 213 and the second joint recess portion 233, in a state in which the upper body 210 and the lower body 230 are brought into contact with each other, may form the joint recess portion 310, and the joint injection portion 330 may be molded by injecting a resin into the joint recess portion 310 during the secondary injecting operation.

In this manner, since the joint injection portion 330 is formed on the combined portion of the first hinge recess portion 211 and the second hinge recess portion 231 constituting the hinge unit 300 through the secondary injecting operation, the combined portion does not have a gap and thus, infiltration of water or feces can be prevented, and since the heater electrical wire led out through the outlet 320 can be stably mounted, an electric shock accident can thus be minimized.

Meanwhile, the upper body 210 may include the inner partition 215 formed on a lower surface thereof and the gap injection portion 217 injection-molded by injecting a resin into a space between the outer surface and the inner partition 215.

Referring to FIGS. 3 and 6, the upper body 210 may be molded to include the inner partition 215 formed on a lower surface thereof.

Namely, the upper body 210 may be formed to have a dual-partition structure including the outer surface and the inner partition 215 to prevent infiltration of water or feces. Here, the inner partition may be formed in at least any one of an inner side and an outer side of the upper body 210, but preferably, in order to reliably block the introduction of water, the inner partition may be formed in both of the inner side and the outer side.

Here, when the upper body 210 and the lower body 230 are combined, a gap may be formed due to assembly, and water or feces may infiltrate into the gap. Thus, in the secondary injecting operation, the gap injection portion 217 may be injection-molded by injecting a resin into the space between the outer surface and the inner partition 215 in the secondary injecting operation.

In order to inject a resin into a space between the outer surface and the inner partition 215, a plurality of resin injection holes (not shown) may be formed in a lower portion of the outer surface of the upper body 210.

Due to the gap injection portion 217 formed as described above, a gap according to combining of the upper body 210 and the lower body 230 can be blocked, and infiltration of water or feces can be reliably blocked, and the heater 250 can be stably installed within the toilet seat body 200.

Meanwhile, the toilet seat 100 according to another embodiment of the present invention will be described with reference to FIGS. 7 to 10.

Referring to FIGS. 7 through 10, the lower body 230 may include a reinforcing rib 237 installed to be protruded to be adjacent to the resin injection hole 235 in order to prevent the upper body 210 and the lower body 230 from being deformed by a resin injected in the secondary injecting operation.

Here, the lower body 230 may include a blocking rib 236 formed to be protruded to correspond to the inner partition 215 of the upper body 210. The blocking rib 236 may be formed in a position corresponding to the inner partition 215 so as to be joined to the inner partition 215, and may serve to prevent a resin injected to form the gap injection portion 217 from overflowing to the outside.

Preferably, the reinforcing rib 237 may be installed to be joined to the blocking rib 235 installed to be adjacent to the resin injection bole 235, Thus, the reinforcing rib 237 is able to reinforce rigidity (or stiffness) of the lower body 230 in the vicinity of the resin injection hole 235 and the blocking rib 236, thus minimizing deformation of the lower body 230 by a high temperature and high pressure resin injected in the secondary injecting operation. Also, since deformation of the blocking rib 236 is minimized, a gap between the upper body 210 and the lower body 230 can be minimized.

However, the installation of the reinforcing rib 237 is not limited to the case in which the reinforcing rib 237 is joined to the blocking rib 236. Namely, for example, when the blocking rib 236 is not installed, the reinforcing rib 237 may be installed to be protruded in the vicinity of the resin injection hole 235. Also, the reinforcing rib 237 is not limited to the case in which the reinforcing rib 237 is formed in the vicinity of the resin injection hole 235, and as in the illustrated embodiment, the reinforcing ribs 237 may be installed at certain intervals in the vicinity of the blocking rib 236.

Meanwhile, the reinforcing rib 237 may be configured as a plurality of vertical ribs 237a formed to be protruded in a vertical direction on the blocking rib 236.

Namely, as shown in the embodiment illustrated in FIG. 7, the vertical ribs 236a may be installed to be perpendicular to both of the blocking rib 236 and a bottom surface of the. lower body 230. Thus, when a resin is injected through the resin injection hole 235, the vertical ribs 237a may increase shoring strength of the blocking rib 236 to minimize deformation.

Meanwhile, the reinforcing rib 237 may be configured as a grid rib 237b coupled to one surface of the blocking rib 236 as a grid.

Namely, as shown in the embodiment illustrated in FIG. 10, the grid rib 237b may be joined to the blocking rib 236 and a bottom surface of the lower body 230 and configured as a grid in which horizontal and vertical ribs intersect with each other, Thus, since stress is distributed between the horizontal and vertical ribs of the grid rib 237b, shoring strength of the blocking rib 236 can be increased, relative to the vertical ribs 237a, thus maximizing the effect of minimizing deformation of the lower body 230.

However, the reinforcing rib 237 is not limited to the vertical rib 237a or the grid rib 237b and may be variously modified as long as it can minimize deformation of the lower body 230 in the vicinity of the resin injection hole 235.

Meanwhile, referring to FIGS. 8 and 9, the primary injecting operation may be performed to form the overlap portion 216 extending to have a certain length on an outer end portion of the upper body 210 and on an end portion of the inner partition 215 to prevent the formation of a gap due to contraction between the upper body 210 and the lower body 230 after the primary injecting operation.

Thus, a problem, in which the resin injected in the secondary injecting operation overflows to an outer side of the space formed by the gap injection portion 217 due to contraction according to cooling of a primary injection molded product in the case that the upper body 210 and the lower body 230 are designed such that end portions thereof are joined without an overlap portion therebetween, can be solved, and the upper body 210 and the lower body 230 can be tightly attached even after cooling.

When the method for manufacturing a toilet seat and the toilet seat according to embodiments of the present invention as described above are used, a gap is not formed in a combined portion of the upper body and the lower body, and thus, water or feces cannot infiltrate into the toilet seat, thus preventing the interior of the toilet from being contaminated, and a generation of an electric shock due to an infiltration of water to the heater disposed within the toilet seat can also be prevented.

Further, according to embodiments of the present invention, since the heater is attached by using a heater jig in the process of manufacturing the toilet seat by injection-molding the upper body and the lower body, the operation of installing the heater in the toilet seat can be simplified, the manufacturing time can be shortened, and a precise operation can be performed in attaching the heater.

While the present invention has been shown and described in connection with the embodiments, it will he apparent to those skilled in the art that modifications and variations can be made without departing from the spirit and scope of the invention as defined by the appended claims.

1. A method for manufacturing a toilet seat, the method comprising:
a primary injecting operation to inject a resin into an upper injection mold and a lower injection mold to injection mold an upper body and a lower body constituting a toilet seat body;
a heater mounting operation to mount a heater on one surface of the upper body by using a heater jig;
a secondary injecting operation to inject a resin in a state in which the upper body and the lower body are brought into contact with each other, to close a gap in the toilet seat body; and
a toilet seat body extracting operation to extract the toilet seat body from the upper injection mold and the lower injection mold.

2. The method of claim 1, further comprising moving the lower injection mold to a position in which the lower body corresponds to the upper body, before the mounting of the heater.

3. The method of claim 1, wherein the mounting of the heater comprises:
a heater fixing operation of fixing the heater to one surface of the heater jig;
a heater jig inserting operation to move the heater-mounted heater jig to a position between the upper body and the lower body;
a heater attaching operation to close the upper injection mold and the lower injection mold to attach the heater to the upper body; and
a heater jig extracting operation to extract the heater jig.

4. The method of claim 1, wherein the mounting of the heater comprises:
a heater fixing operation of fixing the heater to one surface of the heater jig;
a heater attaching operation to move the heater jig to the upper body to attach the heater to the upper body; and
an upper body moving operation to move the heater-attached upper body to a position corresponding to the lower body.

5. The method of claim 4, wherein the upper body is injection-molded by injecting a resin into the lower injection mold, and in the upper body moving operation, the upper body is disposed in a position corresponding to the lower body by moving the lower injection mold.

6. The method of claim 1, wherein the secondary injecting operation comprises molding a joint injection portion by injecting a resin into a joint recess portion formed by a first joint recess portion provided on an outer side of the first hinge recess portion of the upper body and a second joint recess portion provided on an outer side of the second hinge recess portion of the lower body.

7. The method of claim 1, wherein the secondary injecting operation comprises injection-molding a gap injection portion by injecting a resin into a space between an inner partitions provided on an lower surface of the upper body and an outer surface of the upper body.

8. The method of claim 7, wherein the lower body includes a plurality of resin injection holes formed in a penetrative manner to communicate with the space between the outer surface of the upper body and the inner partition and formed along the circumference of the lower body, and
in the secondary injecting operation, the gap injection portion is molded by injecting a resin through the plurality of resin injection holes.

9. The method of claim 8, wherein the lower body includes a reinforcing rib installed to be protruded in the vicinity of the resin injection holes to prevent the upper body and the lower body from being deformed by the resin injected in the secondary injecting operation.

10. The method of claim 9, wherein the lower body includes a blocking rib protruded to correspond to the inner partition of the upper body, and the reinforcing rib is provided as a plurality of vertical ribs protruded in a direction perpendicular to the blocking rib.

11. The method of claim 9, wherein the lower body includes a blocking rib protruded to correspond to the inner partition of the upper body, and the reinforcing rib is provided as a grid rib coupled to one surface of the blocking rib as a grid.

12. The method of claim 1 wherein in the primary injecting operation, the upper body and the lower body are molded simultaneously.

13. The method of claim 7, wherein in the primary injecting operation, an overlap portion is formed to extend to have a certain length on an outer end portion of the upper body and an end portion of the inner partition in order to prevent a formation of a gap due to contraction of the upper body and the lower body after the primary injecting operation.

14. A toilet seat comprising:
a toilet seat body including an upper body having a heater mounted on a lower surface thereof and a lower body combined with the upper body; and
a hinge unit provided in one side of the toilet seat body and having an outlet allowing an electrical wire of the heater to be led out therethrough,
wherein a gap generated as the upper body and the lower body of the toilet seat body are combined is blocked through a secondary injecting operation, and the hinge unit is formed by combining a first hinge recess portion formed on the upper body and a second hinge home recess portion formed on the lower body through a secondary injecting operation.

15. The toilet seat of claim 14, wherein the hinge portion includes a joint injection portion formed by injection molding a resin to form a recess portion formed by a first joint recess on an outer side of the first hinge recess portion and a second joint recess portion formed on the second hinge recess portion.

16. The toilet seat of claim 14, wherein the upper body includes an inner partition formed on a lower surface thereof, and a gap injection portion injection-molded by injecting a resin into a space between an outer surface and the inner partition wall thereof.

17. The toilet seat of claim 16, wherein the lower body comprises:
a blocking rib formed to be protruded to correspond to the inner partition wall of the upper body; and
a plurality of reinforcing ribs formed to be protruded in a direction perpendicular to the blocking rib in order to reinforce the strength of the blocking rib.

18. The toilet seat of claim 16, wherein the lower body comprises:
a blocking rib formed to be protruded to correspond to the inner partition wall of the upper body; and
a reinforcing rib coupled to one surface of the blocking rib as a grid in order to reinforce the strength of the blocking rib.

19. The toilet seat of claim 16, wherein the upper body includes an overlap portion formed to extend to have a certain length on an outer end portion of the upper body and an end portion of the inner partition such that the upper body and the lower body can be combined in an overlapping manner.
